(19) United States
(12) Patent Application Publication
(10) Pub. No.: US 2016/0076932 A1
(43) Pub. Date: Mar. 17, 2016

(54) DISTRIBUTED ACOUSTIC SENSING TO OPTIMIZE COIL TUBING MILLING PERFORMANCE

(71) Applicant: Trican Well Service, Ltd., Calgary (CA)

(72) Inventor: Scott Sherman, Blackie (CA)

(73) Assignee: TRICAN WELL SERVICE, LTD., Calgary (CA)

(21) Appl. No.: 14/851,237

(22) Filed: Sep. 11, 2015

Related U.S. Application Data
(60) Provisional application No. 62/049,129, filed on Sep. 11, 2014.

(51) Int. Cl. G01H 9/00

(52) U.S. Cl. CPC G01H 9/004

(57) ABSTRACT

A method of utilizing fiber-optic cables either previously installed in adjacent wells or currently installed as part of the drilling or milling process to sense vibrations or acoustic signatures within an adjacent or the currently drilled wellbore. The vibrations or acoustic signatures may then be used to determine the location, including the depth, of a tool run into the well on coil tubing. In addition to determining the location of any tools run into the well on coil tubing, a determination of the operating condition of the tools may also be made based upon the vibrations or acoustic signatures of the tools received via the fiber-optic cables.

### CROSS-REFERENCE TO RELATED APPLICATIONS

This application claims priority to U.S. Provisional Patent Application No. 62/049,129 that was filed on Sep. 11, 2014.

### BACKGROUND

Coil tubing milling currently comprises over 70% of the coil tubing market in North America. Milling a single frac plug can take anywhere from less than 5 minutes to a couple of hours.

Milling efficiency is a function of downward pressure on the mill, debris in the mill face which may include pieces from upper plugs that spin with the bit, mill or bit sharpness or condition, and motor stalls.

When a coil tubing mill motor stalls, there is a brief pressure fluctuation that can be observed on surface. The pressure gauge is potentially the only indication that the motor may have stalled provided we are pumping single phase liquid milling fluids. However if 2 phase milling fluids are used, a motor stall may not be detectable by pressure fluctuations on the surface.

Currently, it takes and experienced operator to determine if the mill motor is stalled. Usually such a determination is made by noticing that the mill bit is not advancing within a certain period of time. In such a case the operator will usually pull out of the hole some slight amount, re-engage the motor, and start back down.

There are smart coil bottom hole assemblies that can be used to communicate the weight on the bit, differential pressure, vibration, and torque to surface. These tools provide for a complicated bottom hole assembly and require substantial training to operate. Certain technologies are able to record drilling parameters but these tools do not communicate with surface while milling.

### SUMMARY

Wells with smart completions are becoming more commonplace these days. These wells typically have fiber optic cables permanently installed in them. When fiber optic cables are installed in a well or even in a nearby well the fiber optic cables may be used as a distributed acoustic sensor, a distributed temperature sensor, or a distributed vibration sensor. All of these sensors will be referred to together as distributed sensors.

In general a distributed sensor is able to measure the true acoustic field every 1 m over up to 50 km of fiber optic cable. An optical signal is pulsed into the fiber optic cable. Reflections, caused by acoustic waves vibrating the fiber optic cable are scattered back all along the fiber optic cable. By analyzing these reflections, and measuring the time between the laser pulse being launched and the signal being received, the distributed sensor can measure the acoustic signal at virtually any point along the fiber optic cable.

More specifically, when a pulse of light travels down a fiber optic cable, a small amount of the light is naturally scattered, through Rayleigh, Brilliouin and Raman scattering, and returns to the sensor unit. By comparing the returning signal against a time a measurement of the light generated as well as comparing the frequency of the returning signal to the signal generated the location and frequency of temperature, and acoustic signals all along the fiber optic cable can be determined. The returning and generated signals may be compared to one another by such tools as an optical time domain reflectometer or an optical phase domain reflectometer.

In other instances light pulses are sent down the fiber optic cable where the fiber optic cable includes a number of selectively placed fiber Bragg gratings and wherein the fiber optic cable is acoustically coupled to the coil tubing to allow the acoustic signals to affect the physical status of at least one Bragg grating. The change in the physical status of the Bragg grating, to determine the acoustic signature of the mill motor or mill head, may then be derived at the surface from the change in the frequency, phase, or timing of the transmitted light. Bragg gratings may be used alone or in conjunction with the distributed sensors.

By listening to the acoustic signal generated by the mill motor, mill tool, or drill bit a number of conditions may be determined with great precision. Such conditions include, but are not limited to, the mill condition (a worn mill will have a differently acoustic signature than a new mill), a motor stall (a stalled motor will sound differently than a motor that is turning), debris within the wellbore (a mill not making effective contact or spinning in place without cutting will sound differently from a mill in effective engagement with the target), and the motor condition (prior to failing, or even after failure, bearings and other components generate a particular acoustic signal allowing the operator to determine if the mill motor required maintenance).

By listening or otherwise monitoring the information generated by the distributed sensors while milling with coil tubing in real time conditions that may negatively impact milling efficiency can be easily detected and corrected before causing damage or wasted time.

Additionally because of the extreme accuracy of distributed sensors very accurate coil depth may be determined. In many instances accuracy within 10 cm over 6000 m is possible.

In those instances where fiber optic cable has not been run into the particular well that is being milled with coil tubing, the operator may utilize the fiber optic cable in a nearby well as a distributed sensor. The operator may also use a permanent fiber optic cable or a temporary fiber optic cable that has been conveyed with coil tubing, slickline, casing, or any other means of transport into one or more adjacent wells as a distributed sensor to determine milling efficiency in a well without fiber optic cable installed.

### BRIEF DESCRIPTION OF THE DRAWINGS

FIG. 1 depicts a side view of coil tubing in a well with adjacent wells having fiber optic cables.

FIG. 2 depicts a top view of coil tubing in a well with adjacent wells having fiber optic cables.

### DETAILED DESCRIPTION

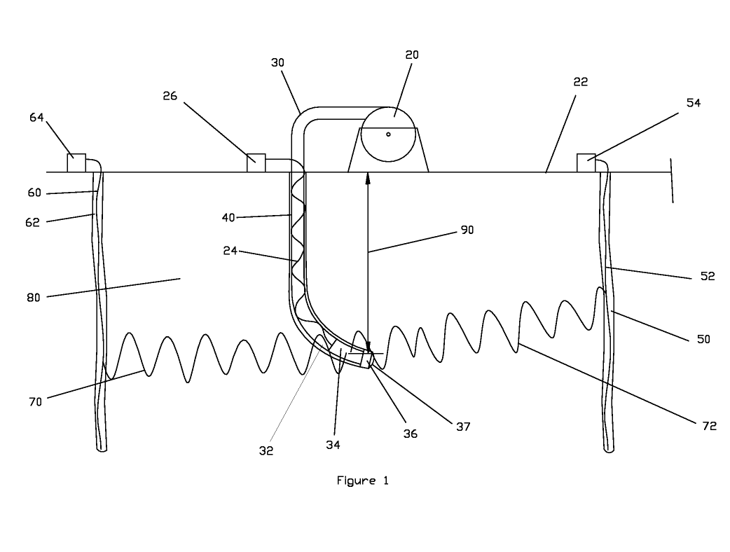

FIG. 1 depicts a coil tubing rig 20 on the surface 22 with the fiber optic line 24 connected to an optical source and detector 26. In this instance the fiber optic line 24 is wrapped around the coil tubing 30 as the coil tubing 30 is lowered into the wellbore. In certain instances the coil tubing 30 may be manufactured or otherwise constructed such that the fiber optic line 24 is within the interior or a wall of the coil tubing 30. Additionally the fiber optic line 24 may be attached to the coil tubing 30 without wrapping the fiber optic line 24 around the coil tubing 30. The coil tubing rig 20 is on spooling a length of coil tubing 30. At the lower end 32 of the coil tubing 30 is a drilling motor 34 attached to drill bit 36. Where drill bit 36 is drilling and is located within wellbore 40. A second wellbore 50 is located adjacent wellbore 40. Within second wellbore 50 is a second fiber optic line 52 and a second optical source and detector 54. A third wellbore 60 is located adjacent wellbore 40. Within third wellbore 60 is a third fiber optic line 62 and a third optical source and detector 64.

As drilling motor 34 turns drill bit 36 the drill bit 36 detaches rock or other material from the lower end 37 of wellbore 40. Typically during the drilling process any of the drill bit 36 or the drilling motor 34 may vibrate. Such vibrations may be caused by the normal operation of the drill bit 36 and the drilling motor 34 as the drill bit cuts through rock. While vibrations have been described as being caused by the drill bit 36 or the drilling motor 34, any such vibrations may be caused by fluid flow, any tool, device, or portion thereof moving within the wellbore 40. Vibrations may also be caused by the imminent failure of the drilling motor 34 or bit, by a dull or damaged drill bit 36, or as the drill bit 36 moves in place without removing rock cuttings or other material from the lower end 37 of wellbore 40. Any such vibrations such as vibrations 70 or 72 will pass through the earth 80 to reach fiber-optic cables 52 and 62. The vibrations 70 or 72 will typically vary as a function of what causes the vibrations whether it was the drill bit 36 or drilling motor 34 and whether each was functioning properly or not.

As the vibrations 70 and 72 reach the fiber-optic cables 52 and 62 the vibrations cause physical changes to occur within the fiber-optic cables 52 and 62. The physical changes in the fiber-optic cables 52 and 62 allow the optical source and detectors 54 and 64 to locate the depth 90 of the device such as drilling motor 34 that is causing the vibrations. Additionally the frequency of any vibrations such as vibrations 70 and 72 coupled with the now known location of any such device causing vibrations will allow the operator to determine the exact location of the drilling motor 34 and drill bit 36 as well as knowing whether any device within the wellbore 40 is functioning properly, nearing a failure mode, or has failed.

While FIG. 1 depicts three different fiber-optic lines 62, 52, and 24 being used to detect vibrations within wellbore 40 any of the fiber-optic lines 62, 52, or 24 may be used singly, as a group, or in conjunction with any other existing and nearby fiber-optic line. Typically as long as a fiber-optic line such as 52 or 64 are near enough to detect vibrations from a device in a wellbore such as wellbore 40 the fiber-optic line may be used to locate devices within wellbore 40 and to determine the devices operating parameters based upon a pre-existing acoustic signature.

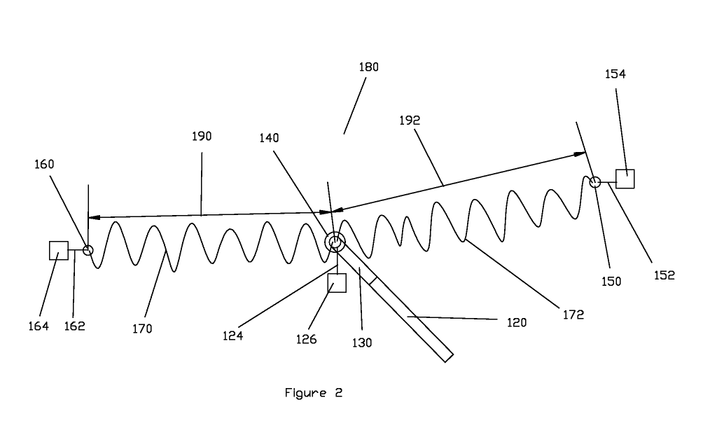

FIG. 2 is a top-down view of a well field having a first existing wellbore 150 and a second existing wellbore 160. A third wellbore 140 is being drilled using a coil tubing rig 122 insert coil tubing 130 into the wellbore 140. At the lower end of coil tubing 130 is a drilling motor and a drill bit. A first fiber-optic line 124 is wrapped around the coil tubing 130 as the coil tubing 130 is lowered into wellbore 140. The fiber-optic line 124 is attached to a first optical source and detector 126. The first existing wellbore 150 is located adjacent wellbore 140. Within first existing wellbore 150 is a second fiber-optic line 152 attached to a second optical source and detector 154. The second existing wellbore 160 is located adjacent wellbore 140. Within second existing wellbore 160 is a third fiber-optic line 162 attached to a third optical source and detector 164.

During the drilling process any of the drill bit or the drilling motor may vibrate or be caused to vibrate. Additionally, vibrations have been described may be caused by any tool, device, or portion thereof moving within the wellbore 140 or fluid flow through the wellbore or the coil tubing. Vibrations may also because to buy the imminent failure or improper operation of tools within the wellbore 140. Any vibrations, such as vibrations 170 or 172, will pass through the earth 180 to reach fiber-optic cables 152, 162, or 124. The vibrations 170 or 172 will typically vary as a function of what causes the vibrations whether caused by fluid flow, the drill bit. or drilling motor and whether or not each was functioning properly.

As the vibrations 170 and 172 reach the fiber-optic cables 124, 152, and 162 the vibrations cause physical changes to occur within the fiber-optic cables 124, 152, and 162. The physical changes in the fiber-optic cables 124, 152, and 162 allow the optical source and detectors 126, 154, and 164 to locate the distance 190 and 192 of the device such as drilling motor that is causing the vibrations from the detecting fiber optic cable. Additionally the frequency of any vibrations such as vibrations 170 and 172 coupled with the now known location of any such device causing vibrations will allow the operator to determine the exact location of the drilling motor and drill bit as well as knowing whether any device within the wellbore 140 is functioning properly, nearing a failure mode, or has failed. In many instances the optical source and detectors will merely supply data and the data will be used to determine location, distance, and operation of the equipment within the wellbore.

While the embodiments are described with reference to various implementations and exploitations, it will be understood that these embodiments are illustrative and that the scope of the inventive subject matter is not limited to them. Many variations, modifications, additions and improvements are possible.

Plural instances may be provided for components, operations or structures described herein as a single instance. In general, structures and functionality presented as separate components in the exemplary configurations may be implemented as a combined structure or component. Similarly, structures and functionality presented as a single component may be implemented as separate components. These and other variations, modifications, additions, and improvements may fall within the scope of the inventive subject matter.

What is claimed is:

1. A method of monitoring coil tubing operations comprising:
sending a signal into a fiber optic cable,
receiving a reflected signal generated by the first signal,
comparing the signal to the reflected signal to determine an acoustic signature in a well,
monitoring the acoustic signature in the well during a coil tubing operation as compared to a predetermined acoustic signature.

2. The method of monitoring coil tubing operations of claim 1 further comprising deploying the fiber optic cable on coil tubing.

3. The method of monitoring coil tubing operations of claim 1 further comprising deploying the fiber optic cable within coil tubing.

4. The method of monitoring coil tubing operations of claim 1 further comprising utilizing the acoustic signature to determine a location where the acoustic signal was generated.

5. A method of monitoring coil tubing operations comprising:
installing a fiber-optic cable within a first wellbore,
sending an optical signal into the fiber optic cable,
generating an acoustic signal within a second wellbore,
receiving a reflected optical signal generated by the first optical signal,
comparing the first optical signal to the reflected optical signal,
monitoring the acoustic signature in the well during a coil tubing operation.

6. The method of monitoring coil tubing operations of claim 5 wherein the fiber-optic cable is installed within the first wellbore on coil tubing.

7. The method of monitoring coil tubing operations of claim 5 wherein the fiber-optic cable is installed within the first wellbore within coil tubing.

8. The method of monitoring coil tubing operations of claim 5 further comprising utilizing the acoustic signature to determine a location where the acoustic signal was generated.

9. The method of monitoring coil tubing operations of claim 5 further comprising utilizing the acoustic signature to determine a condition of a coil tubing device generating the acoustic signal.
